(19) United States
(12) Patent Application Publication
(10) Pub. No.: US 2025/0067931 A1
(43) Pub. Date: Feb. 27, 2025

(54) STRESS-MODIFYING FORMATIONS FOR POLARIZATION CONTROL

(71) Applicant: Ciena Corporation, Hanover, MD (US)

(72) Inventor: Marie-Josee Picard, L'Ancienne-Lorette (CA)

(73) Assignee: Ciena Corporation, Hanover, MD (US)

(21) Appl. No.: 18/808,547

(22) Filed: Aug. 19, 2024

Related U.S. Application Data
(60) Provisional application No. 63/533,778, filed on Aug. 21, 2023.

(51) Int. Cl. G02B 6/124; G02B 6/02; G02B 6/12; G02B 6/126

(52) U.S. Cl. CPC G02B 6/124; G02B 6/02042; G02B 6/021; G02B 6/126; G02B 2006/12147; G02B 2006/12152; G02B 2006/12166

(57) ABSTRACT

A larger-mode region is configured to propagate at least a first optical mode characterized by a first mode field diameter at a first position along a propagation axis of the larger-mode region. A smaller-mode region comprises one core structure embedded within the cladding positioned to couple optical modes guided by the smaller-mode region characterized by a second mode field diameter smaller than the first mode field diameter to the first optical mode over a coupling region within the cladding in which the larger-mode region is in proximity to the smaller-mode region. Stress-modifying formations are arranged within or in proximity to one or both of the larger-mode region or the coupling region, and modify a stress within a portion of the cladding along a first transverse axis with respect to a stress within the portion of the cladding along a second transverse axis.

### CROSS-REFERENCE TO RELATED APPLICATION(S)

This application claims priority to and the benefit of U.S. patent application Ser. No. 63/533,778, entitled “STRESS-MODIFYING FORMATIONS FOR POLARIZATION CONTROL,” filed Aug. 21, 2023, which is incorporated herein by reference.

### TECHNICAL FIELD

This disclosure relates to stress-modifying formations for polarization control.

### BACKGROUND

A silicon-on-insulator (SOI) platform is an example of a silicon photonic (SiPhot) platform, which can be used to make opto-electrical active devices, optical passive devices, and optical waveguides in a Si layer of the SiPhot platform. In a SOI platform, the optical signals carried by the optical waveguides to and from the optical passive devices can be confined within the Si layer, for example, because there is an underlying buried oxide (BOX) layer made up of thermal SiO₂ (e.g., Si oxidized using a thermal process) and an overlying SiO₂ cladding surrounding the Si devices. The index contrast between the high refractive index Si and low refractive index SiO₂ is responsible for the confinement. The SiO₂ cladding can be deposited using a tetra ethyl ortho silicate (TEOS) precursor and a chemical vapor deposition (CVD) technique. Some advantages of SiPhot platforms are: (1) the ability to make both active and passive devices and (2) the ability to make very compact circuits due to the high index contrast between Si and SiO₂.

### SUMMARY

In one aspect, in general, an article of manufacture comprises: a cladding including portions characterized by a cladding index of refraction; a larger-mode region configured to propagate at least a first optical mode characterized by a first mode field diameter at a first position along a propagation axis of the larger-mode region; a smaller-mode region comprising at least one core structure embedded within the cladding, the core structure of the smaller-mode region characterized by an index of refraction that is larger than the cladding index of refraction, and positioned to couple one or more optical modes guided by the smaller-mode region characterized by a second mode field diameter smaller than the first mode field diameter to the first optical mode over a coupling region within the cladding in which the larger-mode region is in proximity to the smaller-mode region; and one or more stress-modifying formations arranged within or in proximity to one or both of the larger-mode region or the coupling region, wherein the stress-modifying formations modify a stress within a portion of the cladding along a first transverse axis orthogonal to the propagation axis with respect to a stress within the portion of the cladding along a second transverse axis orthogonal to the propagation axis and orthogonal to the first transverse axis.

Aspects can include one or more of the following features.

The larger-mode region comprises one or more core structures embedded within the cladding, the core structures of the larger-mode region characterized by an index of refraction that is larger than the cladding index of refraction, and the core structures are arranged to collectively guide at least the first optical mode.

The one or more core structures comprise a plurality of core structures.

The plurality of core structures are in proximity to an edge of a die on which the smaller-mode region is formed.

The one or more core structures are not cylindrically symmetric about the propagation axis.

At least one of the (1) one or more core structures or (2) the one or more stress-modifying formations are embedded within a portion of the cladding characterized by an index of refraction that is larger than the cladding index of refraction.

The cladding comprises a first oxide.

The stress-modifying formations comprise at least one of metal, silicon nitride, silicon oxynitride, silicon, or a second oxide.

The second oxide comprises a different state of the first oxide characterized by different density than the first oxide.

The stress-modifying formations comprises at least one air gap embedded within the cladding.

The article of manufacture further comprises an optical fiber in proximity to the larger-mode region.

The stress-modifying structures induce a birefringence in at least a portion of the core structure of the smaller-mode region such that the portion of the core structure of the smaller-mode region has a first index of refraction along the first transverse axis, the portion of the core structure of the smaller-mode region has a second index of refraction along the second transverse axis, and the first index of refraction is larger than the second index of refraction.

The first transverse axis is associated with a first polarization of at least one optical mode guided by the core structure of the smaller-mode region, the second transverse axis is associated with a second polarization of at least one optical mode guided by the core structure of the smaller-mode region.

The first polarization is associated with a transverse electric optical mode.

The second polarization is associated with a transverse magnetic optical mode.

The first mode field diameter is larger than 5 microns.

In another aspect, in general, a method comprises: forming a cladding including portions characterized by a cladding index of refraction; forming a larger-mode region configured to propagate at least a first optical mode characterized by a first mode field diameter at a first position along a propagation axis of the larger-mode region; forming a smaller-mode region comprising at least one core structure embedded within the cladding, the core structure of the smaller-mode region characterized by an index of refraction that is larger than the cladding index of refraction, and positioned to couple one or more optical modes guided by the smaller-mode region characterized by a second mode field diameter smaller than the first mode field diameter to the first optical mode over a coupling region within the cladding in which the larger-mode region is in proximity to the smaller-mode region; and forming one or more stress-modifying formations arranged within or in proximity to one or both of the larger-mode region or the coupling region, wherein the stress-modifying formations modify a stress within a portion of the cladding along a first transverse axis orthogonal to the propagation axis with respect to a stress within the portion of the cladding along a second transverse axis orthogonal to the propagation axis and orthogonal to the first transverse axis.

Aspects can include one or more of the following features.

The cladding comprises a first oxide.

The stress-modifying formations comprise at least one of metal, silicon nitride, silicon oxynitride, silicon, or a second oxide.

The second oxide is formed by focusing a laser beam onto the first oxide.

Aspects can have one or more of the following advantages.

Some implementations of the stress-modified couplers (SMC) described herein allow for lower coupling losses and better control over polarization. For example, one or more optical fibers may be coupled to one or more stress-modified couplers of a photonic integrated circuit (PIC) that maintain an input polarization along a particular polarization axis associated with the stress-modified coupler using one or more stress-modifying formations arranged in proximity to one or more coupled waveguide structures (e.g., evanescently coupled waveguide structures) or a coupling region between the coupled waveguide structures, as described in more detail below. By incorporating stress-modified couplers in photonic circuit designs the die yield may be increased, especially for products that require a smaller optical power budget. For example, one metric that may be improved by such stress-modified couplers is polarization rotation, which may have a high impact on known good die (KGD) yield. In some example stress-modified coupler examples, the coupling efficiency stability during reliability tests, particularly in harsh environments, may enhanced. The stress-modifying formations may allow a stress-modified coupler that includes a spot size converter (SSC) or a lower index contrast layer (LICL), for example, to lock TE and TM modes to their respective axes and reduce the effects of undesired local stress or waveguide asymmetry that can lead to TE and TM polarization exchange within the SMC.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a schematic diagram of an example photonic integrated circuit, viewed from the side.

FIG. 1B is a schematic diagram of a portion of an example photonic integrated circuit, viewed from the side.

FIG. 1C is a schematic diagram of a portion of an example photonic integrated circuit, viewed from the side.

FIG. 1D is a schematic diagram of a portion of an example photonic integrated circuit, viewed from the side.

FIG. 1E is a schematic diagram of a portion of an example photonic integrated circuit, viewed from the side.

FIG. 1F is a schematic diagram of a portion of an example photonic integrated circuit, viewed from above.

FIG. 1G is a schematic diagram of a portion of an example photonic integrated circuit, viewed from above.

FIG. 2A is a schematic diagram of a portion of an example photonic integrated circuit, viewed along a propagation axis of light.

FIG. 2B is a schematic diagram of a portion of an example photonic integrated circuit, viewed along a propagation axis of light.

FIG. 2C is a schematic diagram of a portion of an example photonic integrated circuit, viewed along a propagation axis of light.

FIG. 2D is a schematic diagram of a portion of an example photonic integrated circuit, viewed along a propagation axis of light.

FIGS. 3A-3E are schematic diagrams of a portion of example photonic integrated circuits, viewed along a propagation axis of light, showing supported optical modes.

### DETAILED DESCRIPTION

Complementary metal-oxide-semiconductor (CMOS) and other fabrication techniques are generally used to fabricate electronic integrated circuits, which operate using electrical signals (e.g., voltage signals and/or current signals). Similar fabrication techniques can be used to fabricate photonic integrated circuits (PICs) in SiPhot or other photonic platforms. PICs often include optical waveguides for transporting optical waves to and from photonic devices. An optical waveguide is a structure that confines and guides the propagation of an electromagnetic wave. Some electromagnetic waves have a spectrum that has a peak wavelength that falls in a particular range of optical wavelengths (e.g., between about 100 nm to about 1 mm, or some subrange thereof), also referred to as optical waves, light waves, or simply light. These optical waveguides can be fabricated, for example, by forming a core structure from material having a higher index of refraction surrounded by a cladding comprising one or more materials (or air) that have a lower refractive index. One potential disadvantage of SiPhot platforms can be high propagation loss encountered by the optical signal in higher index contrast layers (HICLs), which may result from sidewall roughness at the material interface. The impact of sidewall roughness on propagation losses can be exacerbated by a larger magnitude of the index of refraction contrast between the two materials. Consequently, lower index contrast materials can result in lower losses. However, such devices formed in lower index contrast layers (LICLs) can often have a larger footprint.

Fabrication of LICLs can involve starting from a Si or quartz handle, followed by depositing SiO₂ through a process known as Flame Hydrolysis Deposition (FHD) in three successive steps to form a bottom cladding, a core layer, and a top cladding. The core layer can be further developed by lithography to form waveguiding structures. GeO₂ dopants can be added to the core layer during its deposition to increases its index above that of the cladding. The low index contrast between the core and cladding can result in low-loss devices, but with high footprints.

Multi-index contrast structures can monolithically integrate photonic structures comprising LICLs (e.g., structures based on a SiO₂ substrate, and structures sometimes referred to as planar lightwave circuits (PLCs)) with other electronic and/or photonic structures comprising HICLs (e.g., structures based on CMOS-compatible active silicon-on-insulator (SOI) photonic platforms, and/or CMOS electronic platforms).

Using a combination of devices made using both HICLs and LICLs may provide the advantages of each platform. But, there are two potential disadvantages to attempting to package those devices formed from separate platforms: (1) the optical interconnection (coupling) between different devices at the package level can be difficult, and (2) the resulting disparity in footprints can make it challenging for cointegration. Consequently, having multi-index contrast structures can mitigate the above two issues by providing optical coupling at the die level and by monolithically integrating HICLs and LICLs.

There are a large variety of oxide deposition methods used in traditional CMOS platforms (e.g., silicon rich oxide (SRO), Undoped Silicate Glass (USG), High-density plasma (HDP)). Each oxide has unique optical properties and a different refractive index. Thus, exploiting those oxides in a SiPhot platform can enable fabrication of a LICL on a SiPhot die without the use of doping GeO₂ that may be found in stand-alone LICL fabrication. Deposition, patterning, and encapsulation of a relevant oxide can generate high quality LICLs. SiPhot dies can be encapsulated with TEOS-based SiO₂. Thus, one may select an oxide bearing a slightly higher index than TEOS to constitute the core and then, clad further the patterned structure with an additional TEOS layer.

SiPhot platforms may have integrated spot size converters (SSCs), which are devices that may be used to optically interconnect the waveguides coupled to the relatively small Si devices in a PIC with larger external waveguides outside the PIC, such as single mode (SM) or polarization maintaining (PM) fibers. In some examples, minimal coupling losses between a SM fiber and an SSC on SiPhot can be achieved as result of the mode matching between the two waveguides while the SSC is in single mode operation (i.e., no higher modes can propagate). Optical interconnects can be performed by adiabatic transfers (e.g., via a tapered waveguide structure, a structure composed of multiple waveguides, or a single waveguide structure). Adiabatic transfer can be particularly useful if a set of LICLs for the realization of spot-size converters is already present.

When coupling an SSC to an external optical fiber, the SSC may be designed to have an effective refractive index at the facet of the PIC that is very similar to the refractive index of the cladding of the external optical fiber. Such a design can make the SSC be more sensitive than a Si waveguide to local defects or stresses that applied to it, which in turn may lead to an undesired polarization rotation of the optical mode within the SSC. One physical mechanism for this sensitivity can be related to the fact that the effective refractive index of the SSC near the facet is similar for transverse electric (TE) and transverse magnetic (TM) modes, resulting in degenerate or nearly-degenerate TE and TM modes.

Another problem that can occur in an SSC is if the TE and TM effective index are similar and a Si inverted taper, often used in SSC designs, has a waveguide cross-section that is squared at one or more locations and some waveguide asymmetry defects are encountered. In such a scenario, uncontrolled TE→TM and TM→TE mode transfers can occur in the SSC cross-section and may limit the on-chip performance. For example, some SSC designs comprise an inverted taper Si waveguide with a first rectangular cross-section with a first aspect ratio (e.g., 1:2), a square cross-section (i.e., 1:1), and a second rectangular cross-section with a second aspect ratio (e.g., 2:1). Such an aspect ratio inversion can reduce coupling losses in the SSC, but decreased polarization control may occur in proximity to the square cross-section.

Herein, stress-modifying formations in or around the cladding of an SMC (e.g., an SSC or a LICL) are disclosed that intentionally create a difference between the effective refractive indices of TE and TM modes. Such a difference in the effective refractive indices has the benefit of locking (i.e., maintaining) the TE mode to remain in the TE mode and the TM mode to remain in the TM mode along the SMC. In some examples, the stress (or lack of stress) induced by the stress-modifying formation may be stronger than the local stress induced by defects in the SMC, thus leading to stress in the cladding that strictly orients the vertical and horizontal axes of the SMC. The stress-modifying formations may be located along the propagation axis of a SMC and sufficiently close to the SMC to perturb the effective refractive indices of the TE and TM modes, but sufficiently far to allow for a larger mode field diameter to match the SM or PM optical fiber.

One method for creating stress-modifying formations utilizes deposition of a patterned layer of material within the fabrication process flow. The patterned layer of material may comprise metal (e.g., Al or TiN), silicon nitride, oxide with a different density than the oxide used as a cladding, or silicon.

Another method for creating stress-modifying formations focuses a laser beam to induce stress in the cladding of the SMC. This method may also be referred to as photo-inscription or laser trimming (e.g., using focused optical energy to increase the refractive index of the cladding or another material in certain regions).

In some examples, the stress-modifying formations may be located in or around an SMC with a mode that matches a standard fiber and which has a modal effective refractive index of its core similar to its cladding refractive index. The stress-modifying formations may also be used in or around an SMC that has a TE and TM effective index coincidence in a specific waveguide, such as in a silicon inverted taper that is often used in a SSC design. In some examples, stress-modifying formations may be devoid of material and only comprise air or vacuum.

In some example small mode field diameter SSC configurations, it may be possible to maintain an effective refractive index difference between TE and TM modes and thus limit or reduce undesired polarization rotation. SSCs with small mode field diameters may still suffer loss of polarization control in regions having a square or nearly square cross-sectional area (e.g., as can occur in an inverted taper Si waveguide), and therefore may still benefit from the inclusion of stress-modified formations in their design. Furthermore, such SSCs may have limited applications (e.g., coupling into a lensed fiber, a high numerical aperture fiber, or a laser SSC) and may require specialized high numerical aperture fibers that may be formed by adapting a standard SM or PM fibers. The resulting fibers may be bulky and can introduce loss and some polarization rotation. In general, using a SSC for a standard fiber mode field diameter leads to degenerate TE and TM modes that are prone to local stress and defects that could introduce coupling efficiency fluctuations, especially in harsh temperature and humidity conditions.

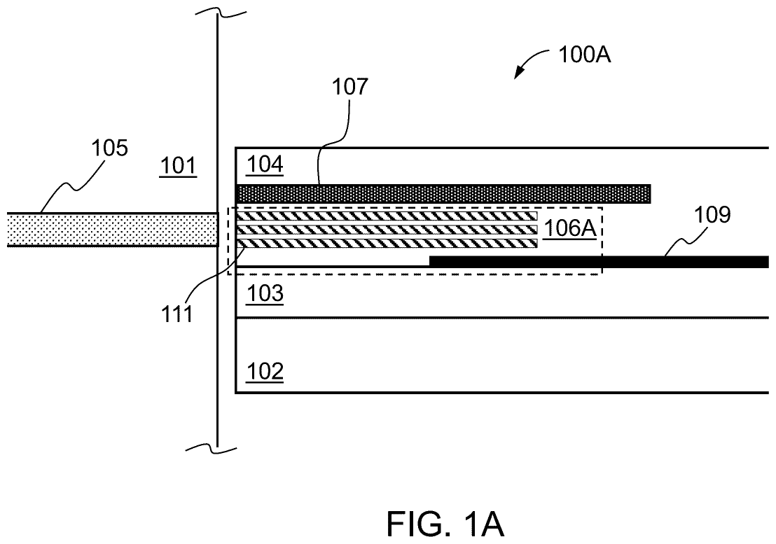

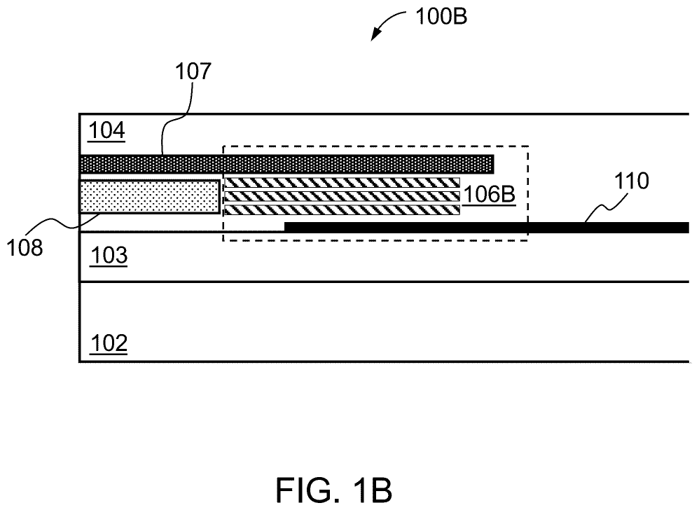

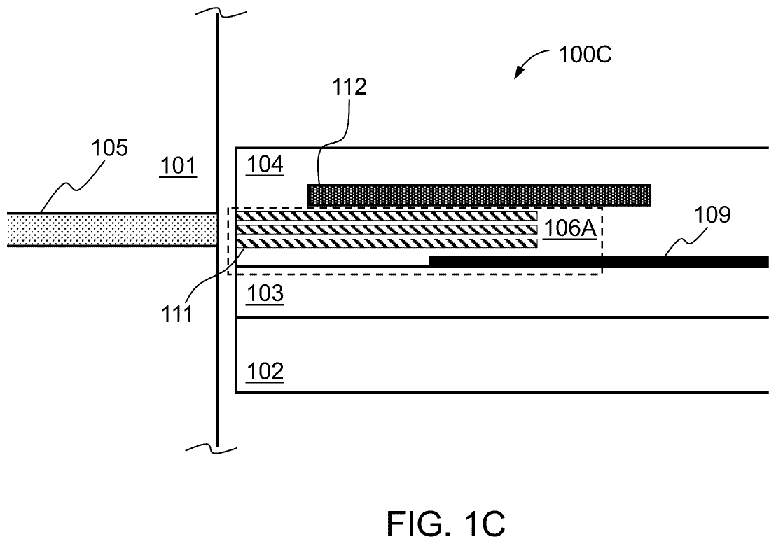

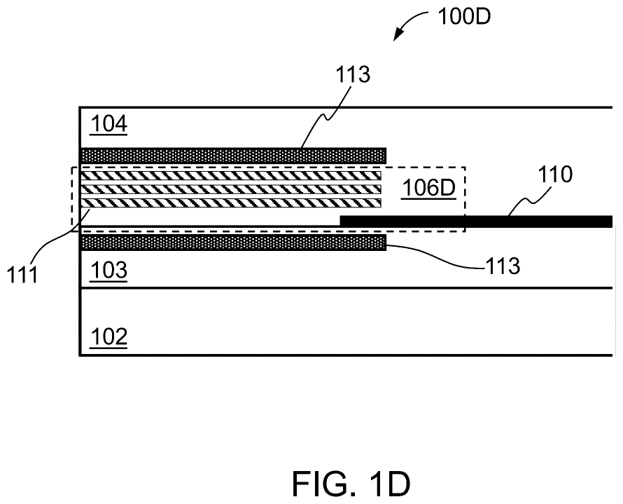

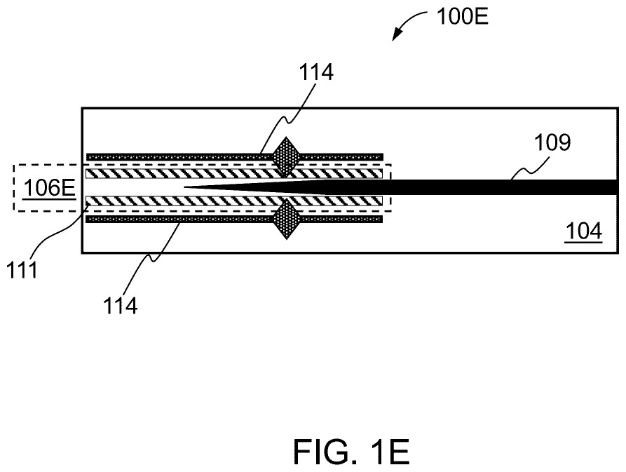

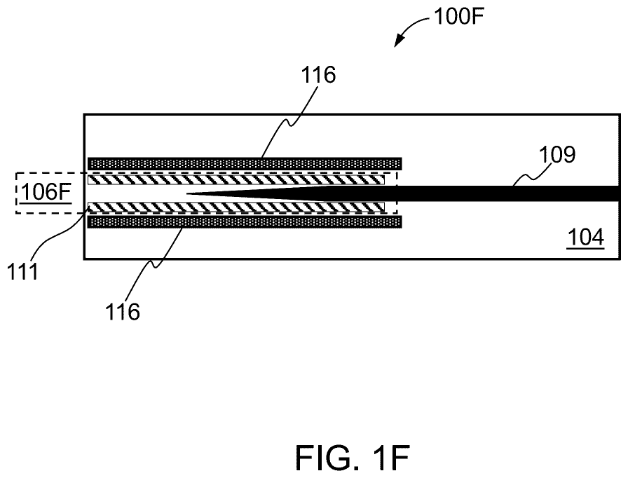

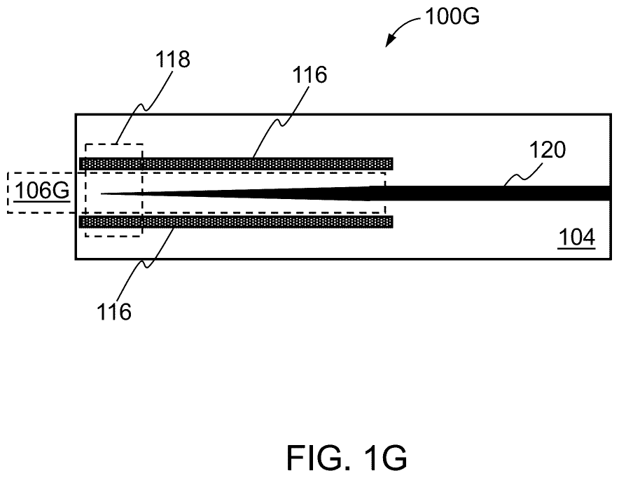

FIG. 1A shows a portion of an example PIC 100A optically coupled to a core 105 of an external optical fiber 101, viewed from the side. The external optical fiber 101 also has a cladding surrounding the core 101. The PIC 100A comprises a Si handle 102, a buried oxide layer 103 (BOX layer), and a SiO₂ layer 104 that serves as the cladding. An SSC 106A is located below a stress-modifying formation 107 and optically couples the external optical fiber 101 and an inverted taper Si waveguide 109, which defines a smaller-mode region of the SSC 106A. The SSC 106A can comprise multiple waveguide cores 111 (as in this example) or a single waveguide core at a larger-mode region of the SSC 106A, which may be composed of SiN or SiON, for example. In this example, the SSC 106A maintains a constant width and constant effective index of refraction over a particular length to achieve coupling. In other examples, the SSC 106A may optically couple the external optical fiber 101 and the Si waveguide 109 via adiabatic coupling, which may be achieved through changing the effective index of refraction of the SSC 106A (e.g., by tapering the width of the waveguide structure comprising the SSC 106A). Evanescent coupling between the smaller-mode region of the inverted taper Si waveguide 109 and the larger-mode region of the SSC 106A can depend on the respective overlap of their waveguide structures, as well as their respective indices of refraction. Additional stress-modifying formations (not shown) may be located within or adjacent to the SSC 106A. For visual clarity, additional layers within the SiO₂ layer 104 may have been omitted (e.g., the SiO₂ layer 104 may comprise pre-metal dielectric SiO₂ deposited on top of the buried oxide layer 103). Furthermore, the cladding may include portions characterized different indices of refraction. In some implementations, most portions of a cladding may be characterized by a particular “cladding index of refraction” but other portions of the cladding may be characterized by different indices of refraction. For example, the SiO₂ layer 104 surrounding the SSC 106A may have a different density than the SiO₂ layer 104 surrounding the Si waveguide 110, thus providing respective portions of the cladding with differing indices of refraction.

Using various etching steps prior to oxide deposition, LICLs may be formed at different heights within the semiconductor stack. For example, an etch may be formed at the level of an existing SSC which then transfers to a device layer. The light may first be coupled from an external optical fiber to one or more LICLs which are coupled to an SSC in a direct fashion (as opposed to an adiabatic transfer).

FIG. 1B shows a portion of an example PIC 100B, viewed from the side, wherein an LICL core 108 is vertically aligned with an SSC 106B and is optically coupled to the SSC 106B. The LICL core 108, or other larger mode field diameter waveguide structure, can be used to propagate an optical wave to another part of the PIC 100B, including to an edge of the PIC 100B for coupling to an external optical fiber. The SSC 106B is located below a stress-modifying formation 107 and is evanescently coupled to a Si waveguide 110. The LICL core 108 may be fabricated by performing etching (i.e., removing a portion of one or more layers) after other layers (e.g., the SSC 106B) have been fabricated. The SSC 106B may optically connect the LICL core 108 via direct coupling in such an example. In other examples, the SSC 106B can be replaced with other coupler types, such as inverted tapers, and/or can be used to couple to other waveguide structures on the PIC or external to the PIC.

FIG. 1C shows a portion of an example PIC 100C, viewed from the side. This example is similar to the PIC 100B, except in the PIC 100C a stress-modifying formation 112 does not extend all the way to the end of the waveguide cores 111.

FIG. 1D shows a portion of an example PIC 100D, viewed from the side. Stress-modifying formations 113 are in both a buried oxide layer 103 and an SiO₂ layer 104 that forms a cladding for an SSC 106D. The SSC 106D is evanescently coupled to a Si waveguide 110. In this example, the stress-modifying formations 114 are located vertically above and below the SSC 106D.

In general, stress-modifying formations can have varying shapes and thicknesses over their length. Some stress-modifying formations may be tapered or have additional structure such that more stress is induced near the facet of a PIC, where the degeneracy of TE and TM modes in the SSC may be large if the stress-modifying formations were not included. Additional stress from the stress-modifying formations may also be applied near where an inverted taper Si waveguide has a square cross-sectional area, thereby enhancing polarization control.

FIG. 1E shows a portion of an example PIC 100E, viewed from above. Stress-modifying formations 114 are in an SiO₂ layer 104 that forms a cladding for an SSC 106E. The SSC 106E is evanescently coupled to an inverted taper Si waveguide 109. In this example, the stress-modifying formations 114 are horizontally displaced from the SSC 106E and have additional, non-rectangular structure that induces more stress near where the inverted taper Si waveguide 109 has a square cross-sectional area. The increased stress applied near the square cross-sectional area can reduce loss of polarization, since that region is more susceptible to a degeneracy between different modes.

FIG. 1F shows a portion of the example PIC 100F, viewed from above. Stress-modifying formations 116 are in an SiO₂ layer 104 that forms a cladding for an SSC 106F. The SSC 106F is evanescently coupled to an inverted taper Si waveguide 109. In this example, the stress-modifying formations 114 are horizontally displaced from the SSC 106F.

FIG. 1G shows a portion of an example PIC 100G, viewed from above. Stress-modifying formations 116 are in an SiO₂ layer 104 that forms a cladding for a single-waveguide SSC 106G that comprises a larger-mode region 118 in proximity to a small end of an adiabatically tapered (e.g., tapered slowly over a relatively long distance compared to a wavelength of the guided light, such as by a factor of 10, 100, or 1000) inverted taper Si waveguide 120. In this example, the stress-modifying formations 116 are horizontally displaced from the SSC 106G. The larger-mode region 118 does not include any waveguide cores 111 or 208 shown in some of the other examples and views but is still able to support a larger optical mode characterized by a mode field diameter at a position along a propagation axis of the inverted taper Si waveguide 120 that is close to the small end of the taper (and in this example also close to the end facet of the PIC 100G). This enables light in the smaller-mode region of the inverted taper Si waveguide 120 to be adiabatically coupled to the larger mode region 118. The light in the larger-mode region 118 can be an unguided optical mode (i.e., an optical mode corresponding to a distribution of optical energy that has propagated into a region of substantially uniform index of refraction from a portion of an optical waveguiding structure that has ended, whether abruptly, adiabatically, or anywhere in between), or can be propagating within a cladding mode that is guided by a portion of the cladding formed by the SiO₂ layer 104 (e.g., where air can serve as a cladding around the cladding material).

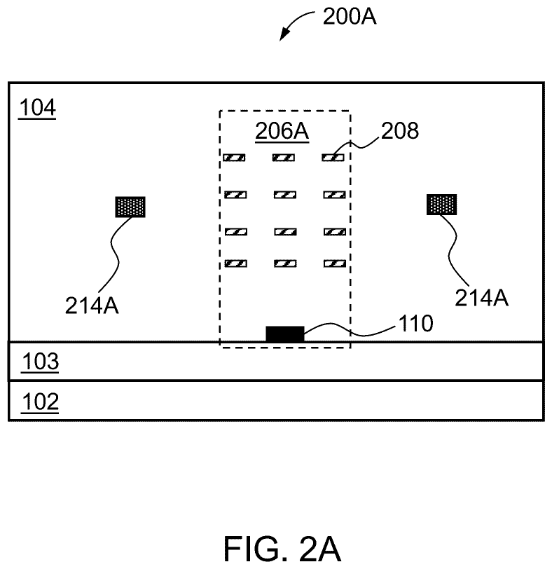

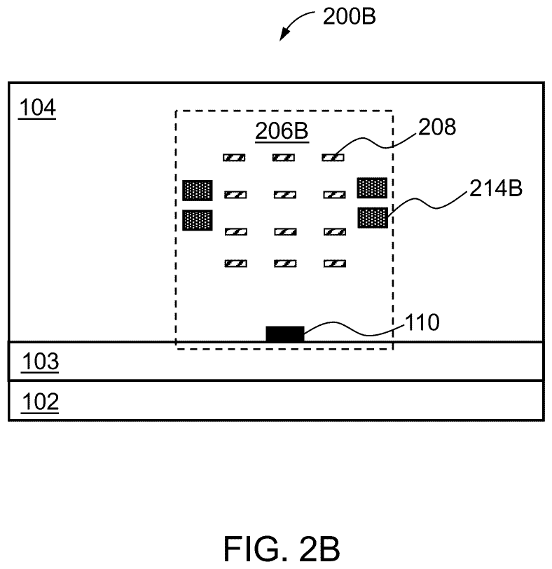

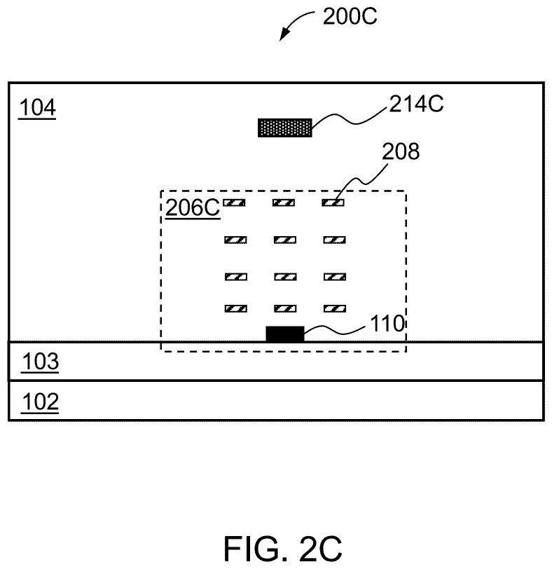

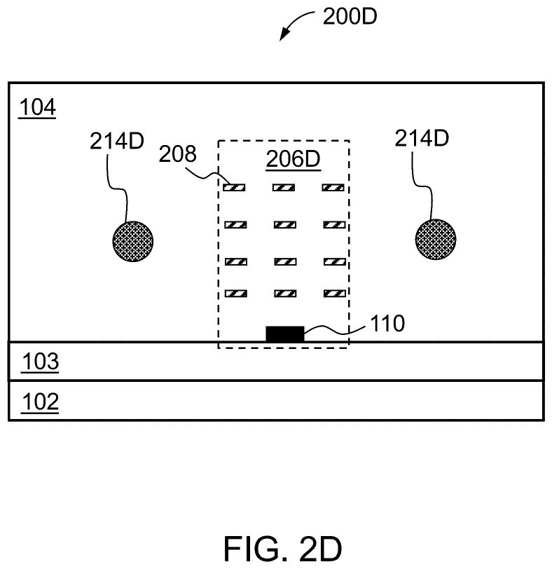

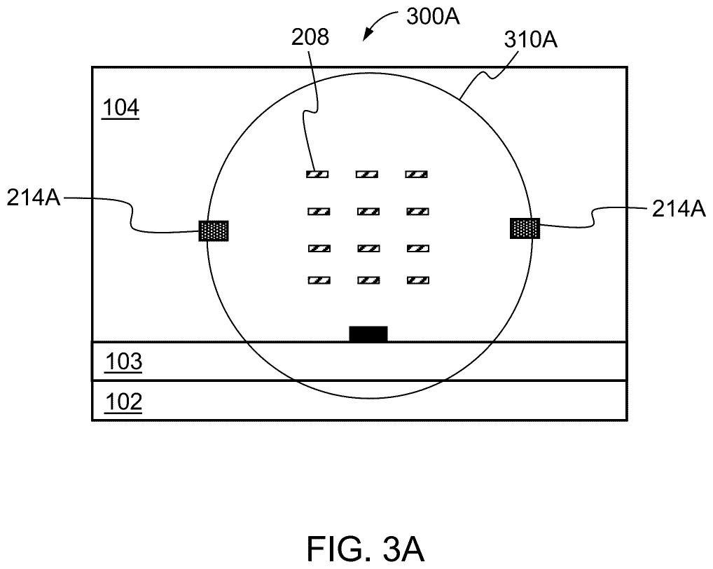

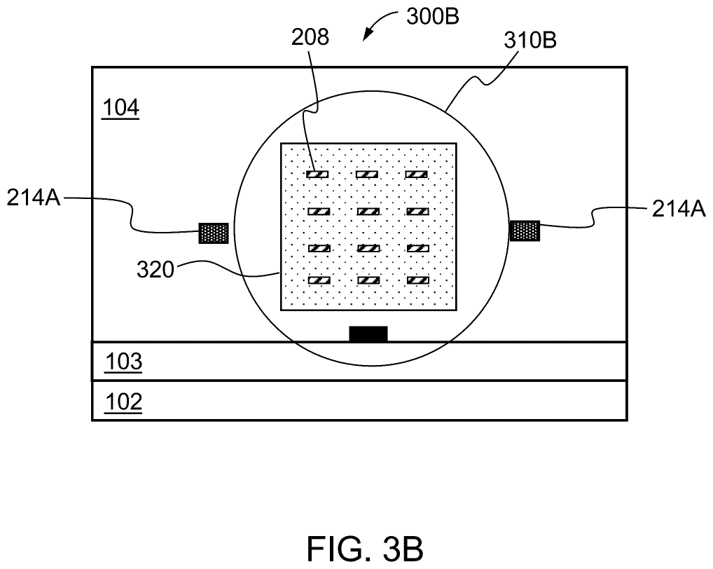

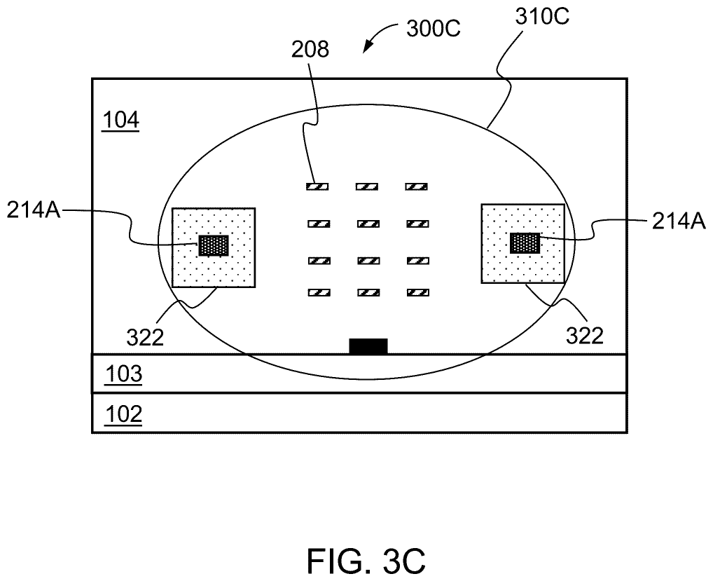

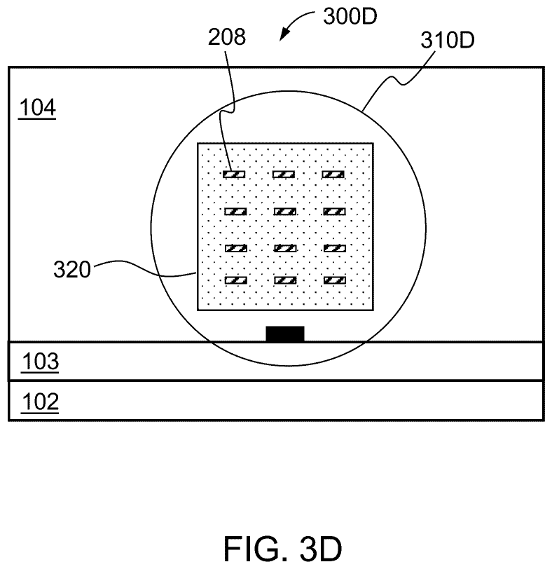

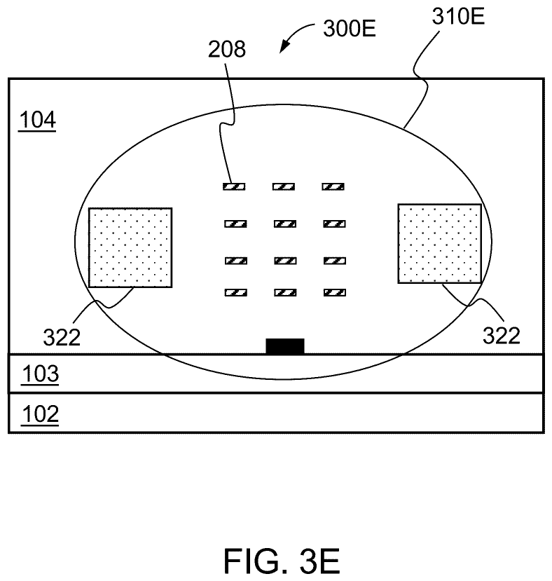

FIG. 2A shows a portion of an example PIC 200A, viewed along a propagation axis of light. Stress-modifying formations 214A are in an SiO₂ layer 104 that forms a cladding for an SSC 206A. The SSC 206A is evanescently coupled to a Si waveguide 110. The SSC 206A can have one or multiple cores that have an index of refraction larger than the cladding. In this example, there are multiple cores 208 that support a large mode profile, as shown in more detail below with reference to FIG. 3B, that is coupled to a smaller mode of the Si waveguide 110. The two stress-modifying formations 214A are horizontally offset from the SSC 206A. The asymmetric arrangement of the stress-modifying formations 214A results in a first transverse stress along the horizontal direction that is different from a second transverse stress along the vertical direction. The difference in stress along the two directions orthogonal to the direction of propagation causes a difference in the effective index of refraction for light polarized along the vertical direction when compared to light polarized along the horizontal direction (known as birefringence), thereby reducing polarization rotation along the SSC 206A. In some examples, the stress-modifying formations 214A may have a non-negligible amount light traversing them, thus making the stress-modifying formations 214A part of the cladding for the SSC 206A. In other examples, the stress-modifying formations 214A have a negligible amount of light traversing them. In general, the SSC 206A may have a varying mode field diameter so as to efficiently couple two waveguides that possess mode field diameters that differ from one another. For example, one portion of the SSC 206A may have a smaller mode field diameter and a smaller effective refractive index to match the Si waveguide 110 effective refractive index, while another portion of the SSC 206A may have a larger mode field diameter to match an external fiber (not shown). The SSC 206A may be located in proximity to the Si waveguide 110 (e.g., within the mode field diameter of the SSC 206A at a certain position) so as to evanescently couple light between the SSC 206A and the Si waveguide 110.

FIG. 2B shows a portion of an example PIC 200B, viewed along a propagation axis of light. Stress-modifying formations 214B are in the SiO₂ layer 104 that forms a cladding for an SSC 206B. The SSC 206B is evanescently coupled to the Si waveguide 110. In this example, four stress-modifying formations 214B are horizontally offset from the SSC 206B.

FIG. 2C shows a portion of an example PIC 200C, viewed along a propagation axis of light. Stress-modifying formations 214C are in the SiO₂ layer 104 that forms a cladding for an SSC 206C. The SSC 206C is evanescently coupled to the Si waveguide 110. In this example, there is only one stress-modifying formation 214C that is above the SSC 206C, leading to a possibly highly asymmetric stress applied to the SiO₂ layer 104.

FIG. 2D shows a portion of an example PIC 200D, viewed along a propagation axis of light. Stress-modifying formations 214D are in the SiO₂ layer 104 that forms a cladding for an SSC 206D. The SSC 206D is evanescently coupled to the Si waveguide 110. In this example, the stress-modifying formations 214D are horizontally offset from the SSC 206D and have a cylindrical shape. In general, the shape of the stress-modifying formations can be selected to achieve favorable polarization maintaining properties in the SSC 206D and in practice may be designed to have a gradient pattern ranging from high applied stress to low applied stress, rather than a sharp interface.

FIG. 3A shows a portion of an example PIC 300A, similar to the example PIC 200A of FIG. 2A, viewed along a propagation axis of light. The multiple cores 208 that have an index of refraction larger than the cladding of the SiO₂ layer 104 support a maximum mode profile 310A after spot size conversion (from small to large) that is relatively large, shown by an outline indicating a diameter at which the intensity of the mode has dropped to a predetermined value, which is shown with an approximately circular shape in this example for simplicity, though the actual mode shape may be different. The mode field diameter of the mode profile 310A is large enough such that a lower portion of the mode overlaps with a portion of the Si handle 102. Since the Si handle 102 (unlike the BOX layer 103) has a larger index of refraction than the SiO₂ layer 104, some optical power can be leaked into the Si handle 102. This may cause a loss that in some use cases is potentially detrimental to performance. The leakage loss due to this mode shape and/or size can be reduced or eliminated in a variety of ways.

FIG. 3B shows a portion of an example PIC 300B, viewed along a propagation axis of light, that is configured to mitigate loss using a first example of an intermediate index distribution. In this example, there is an intermediate cladding 320 surrounding the cores 208, where the intermediate cladding 320 has an index of refraction that is intermediate between the index of refraction of the cores 208 and an index of refraction of the SiO₂ layer 104 that is still used as an outer cladding. For example, the index of refraction can be increased using a laser trimming technique that raises the index of refraction of the SiO₂ in a selected region along a portion of the propagation axis. The effect of this intermediate cladding 320 is to form a smaller maximum mode profile 310B after spot size conversion. Thus, in this example, there is no significant mode overlap with any part of the Si handle 102. Even a relatively small increase in index of refraction (e.g., an increase of around 0.001) can cause enough of a reduction in mode field diameter to significantly reduce the leakage loss.

FIG. 3C shows a portion of an example PIC 300C, viewed along a propagation axis of light, that is configured to mitigate loss using a second example of an intermediate index distribution. In this example, there are two regions of intermediate cladding 322 surrounding each of the stress-modifying formations 214A, where the intermediate cladding 322 has an index of refraction that is intermediate between the index of refraction of the cores 208 and an index of refraction of the SiO₂ layer 104 that is still used as an outer cladding. The effect of this intermediate cladding 322 is to form a stretched shape of the maximum mode profile 310C after spot size conversion. This stretched shape occurs because more of the optical power in the mode profile is concentrated near the locations of higher index of refraction. Thus, in this example, there is also no significant mode overlap with any part of the Si handle 102.

In some implementations, the intermediate cladding structures can be distributed in different portions of the PIC than the stress-modifying structures, or intermediate cladding structures can be included without any stress-modifying structures being present. FIG. 3D shows a portion of an example PIC 300D similar to the PIC 300B except without the stress-modifying formations 214A being present in that particular cross-section of the PIC 300D. For example, the intermediate cladding 320 used to provide the smaller maximum mode profile 310D can be located along a portion of the propagation axis closer to a facet of the PIC 300D and the stress-modifying formations (not shown) can be located along a portion of the propagation axis further from the facet of the PIC 300D. Or, the stress-modifying formations can be absent in some implementations.

FIG. 3E shows a portion of an example PIC 300E similar to the PIC 300C except without the stress-modifying formations 214A being present in that particular cross-section of the PIC 300E. For example, the intermediate cladding 322 used to provide the stretched maximum mode profile 310E can be located along a portion of the propagation axis closer to a facet of the PIC 300E and the stress-modifying formations (not shown) can be located along a portion of the propagation axis further from the facet of the PIC 300D. Or, the stress-modifying formations can be absent in some implementations.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An article of manufacture comprising:
a cladding including portions characterized by a cladding index of refraction;
a larger-mode region configured to propagate at least a first optical mode characterized by a first mode field diameter at a first position along a propagation axis of the larger-mode region;
a smaller-mode region comprising at least one core structure embedded within the cladding, the core structure of the smaller-mode region characterized by an index of refraction that is larger than the cladding index of refraction, and positioned to couple one or more optical modes guided by the smaller-mode region characterized by a second mode field diameter smaller than the first mode field diameter to the first optical mode over a coupling region within the cladding in which the larger-mode region is in proximity to the smaller-mode region; and
one or more stress-modifying formations arranged within or in proximity to one or both of the larger-mode region or the coupling region, wherein the stress-modifying formations modify a stress within a portion of the cladding along a first transverse axis orthogonal to the propagation axis with respect to a stress within the portion of the cladding along a second transverse axis orthogonal to the propagation axis and orthogonal to the first transverse axis.

2. The article of manufacture of claim 1, wherein the larger-mode region comprises one or more core structures embedded within the cladding, the core structures of the larger-mode region characterized by an index of refraction that is larger than the cladding index of refraction, and the core structures are arranged to collectively guide at least the first optical mode.

3. The article of manufacture of claim 2, wherein the one or more core structures comprise a plurality of core structures.

4. The article of manufacture of claim 3, wherein the plurality of core structures are in proximity to an edge of a die on which the smaller-mode region is formed.

5. The article of manufacture of claim 2, wherein the one or more core structures are not cylindrically symmetric about the propagation axis.

6. The article of manufacture of claim 2, wherein at least one of the (1) one or more core structures or (2) the one or more stress-modifying formations are embedded within a portion of the cladding characterized by an index of refraction that is larger than the cladding index of refraction.

7. The article of manufacture of claim 1, wherein the cladding comprises a first oxide.

8. The article of manufacture of claim 7, wherein the stress-modifying formations comprise at least one of metal, silicon nitride, silicon oxynitride, silicon, or a second oxide.

9. The article of manufacture of claim 8, wherein the second oxide comprises a different state of the first oxide characterized by different density than the first oxide.

10. The article of manufacture of claim 1, wherein the stress-modifying formations comprises at least one air gap embedded within the cladding.

11. The article of manufacture of claim 1, further comprising an optical fiber in proximity to the larger-mode region.

12. The article of manufacture of claim 1, wherein the stress-modifying structures induce a birefringence in at least a portion of the core structure of the smaller-mode region such that the portion of the core structure of the smaller-mode region has a first index of refraction along the first transverse axis, the portion of the core structure of the smaller-mode region has a second index of refraction along the second transverse axis, and the first index of refraction is larger than the second index of refraction.

13. The article of manufacture of claim 1, wherein the first transverse axis is associated with a first polarization of at least one optical mode guided by the core structure of the smaller-mode region, the second transverse axis is associated with a second polarization of at least one optical mode guided by the core structure of the smaller-mode region.

14. The article of manufacture of claim 13, wherein the first polarization is associated with a transverse electric optical mode.

15. The article of manufacture of claim 13, wherein the second polarization is associated with a transverse magnetic optical mode.

16. The article of manufacture of claim 1, wherein the first mode field diameter is larger than 5 microns.

17. A method comprising:
forming a cladding including portions characterized by a cladding index of refraction;
forming a larger-mode region configured to propagate at least a first optical mode characterized by a first mode field diameter at a first position along a propagation axis of the larger-mode region;
forming a smaller-mode region comprising at least one core structure embedded within the cladding, the core structure of the smaller-mode region characterized by an index of refraction that is larger than the cladding index of refraction, and positioned to couple one or more optical modes guided by the smaller-mode region characterized by a second mode field diameter smaller than the first mode field diameter to the first optical mode over a coupling region within the cladding in which the larger-mode region is in proximity to the smaller-mode region; and
forming one or more stress-modifying formations arranged within or in proximity to one or both of the larger-mode region or the coupling region, wherein the stress-modifying formations modify a stress within a portion of the cladding along a first transverse axis orthogonal to the propagation axis with respect to a stress within the portion of the cladding along a second transverse axis orthogonal to the propagation axis and orthogonal to the first transverse axis.

18. The method of claim 17, wherein the cladding comprises a first oxide.

19. The method of claim 18, wherein the stress-modifying formations comprise at least one of metal, silicon nitride, silicon oxynitride, silicon, or a second oxide.

20. The method of claim 19, wherein the second oxide is formed by focusing a laser beam onto the first oxide.
